(19) United States
(12) Patent Application Publication
(10) Pub. No.: US 2009/0063328 A1
(43) Pub. Date: Mar. 5, 2009

(54) Systems and Methods for Consumer Mortgage Debt Decision Support

(76) Inventors: Samuel T. Cuscovitch, Coventry, CT (US); David Yale Schlossman, Burlingame, CA (US)

Correspondence Address: SAMUEL T. CUSCOVITCH, 147 OAKWOOD DRIVE, COVENTRY, CT, 06238, US

(21) Appl. No.: 11/849,331

(22) Filed: Sep. 3, 2007

(51) Int. Cl. G06Q 40/00

(52) U.S. Cl. 705/38

(57) ABSTRACT

The subject of debt and home mortgage financing play a critical role in consumer finance, yet its treatment within the framework of personalized financial planning has lagged in relation to breadth and complexity of debt instruments that are commonly available in the marketplace.

Consumers require a decision support system to make informed choices related to debt financing.

A strategic decision framework and a set of tools to properly assess consumer debt are lacking. Monte Carlo simulation, risk tolerance, and statistical methods are frequently in other areas of consumer finance, particularly the investment field. Similar methods have application in the debt domain.

### FIELD OF THE INVENTION

The present invention relates to consumer borrowing and debt and, in particular, to an analytical system and methods used to determine optimal decisions with respect to acquiring, leveraging, managing, converting, or terminating indebtedness due to mortgage loans for real estate.

### BACKGROUND OF THE INVENTION

In 2007, the subprime mortgage market, structured on consumers with little or no credit worthiness, collapsed, threatening both consumers and the global economy. The effects of this collapse and similar spiking foreclosures throughout the banking industry were far reaching, causing: (1) the failure of several major lending institutions, and (2) damaging effects on the financial markets and (3) forcing unprecedented massive liquidity infusion by global central banks. Congressional investigations were launched to identify systemic issues and underlying causes of this debacle. Root causes include several possibilities but some of the primary causes may be the result of: failure of consumers and lenders to properly analyze loan volatility; inability to anticipate uncertainties as a byproduct of many of the new, popular forms of lending instruments, such as Adjustable Rate Mortgages (ARM); failure of consumers and lenders to identify anti-preference high risk loans; failure to adequately disclose loan volatility; failure to consider full life-cycle costs of a loan.

In response the problem in the subprime mortgage market, some fear exists that regulators, lawmakers and policy makers may overreact by: (1) developing overly stringent lending criteria, or (2) eliminating certain classes of so-called risky loans that actually benefit consumers if they were given the proper information, analysis, and disclosure to begin with.

Currently various decision support systems (DSS) exist to assist lending decisions. However, these are designed to help lenders determine borrower qualifications and are intended mainly for use by loan producers and servicers to mitigate their risk in offering loans to consumers. Consumers need their own systems, methods, and comprehensive tools designed to make decisions in their best interests such that the consumer is able to fully identify both risks and opportunities associated with any given lender's loan offering. As a result, consumers can be better prepared to either engage in mortgage loans they can successfully terminate, or avoid unnecessary risks taken through lack of proper information, analysis, and disclosure.

So-called debt calculators exist and have been popularized on the worldwide web. Critics contend that these are nothing more than an inducement to steer consumers to a sponsoring web site's mortgage or other lending broker, as an initial step in a sales process. Further, web-based calculators do not address the issue of future uncertainty and volatility that are an essential element of non-traditional loans often referred to as exotic loans. Nor do these calculators: (1) consider historical data in any fashion as a context and reference for projecting future volatility that can either benefit or be catastrophic to the consumer, and (2) address full life-cycle costs that involve both front- and back-end fees. Ignoring full life cycle costs has the effect of causing excessive transactions and fees. Most importantly, existing tools do not help consumers in identifying when it may be desirable to refinance as a method for optimizing their debt commitment, i.e., reducing their debt risk and maximizing their chance of successful debt termination.

With respect to lender DSS and the failure of various subprime lenders, one can argue that current decision support systems (DSS) may not have adequately supported the lenders' missions (e.g. profitability), much less that of the consumer's. Either these DSS have been: improperly designed for lenders; not used properly by lenders; or not used. Despite whatever arguable merits these DSS might have for producers, DSS have not proven themselves to offer consumer reliability. Consumers cannot rely on tools designed for lenders.

To maximize analytic integrity and to level the playing field for the consumer, consumers need an empowering DSS specifically targeted for their use. These DSS must address full life-cycle costs that include the net present value of all payments: principal; interest; balloon; loan origination, prepayment penalty fees, and termination fees; late fees; carry-over fees. A critical element of this invention is the notion that, in order to make an optimal decision concerning any home mortgage loan or refinance, the life-cycle costs of an initial loan must be fully resolved by evaluating downstream refinancing decisions. The method presumes that loan life cycle costs are not wholly predicated on the expected performance of only the initial loan, especially since refinancing is a persistent option and routinely acted upon by consumers.

It is an object of the invention to help consumers understand their tolerance towards risk and volatility as it relates to mortgage debt.

It is a further object of the invention to provide a comprehensive data schema capable of modeling the variety of consumer mortgage options and fees commonly found in the marketplace.

It is a further object of the invention to address the issue of interest rate volatility for the various interest rate indices that comprise common adjustable and non-adjustable mortgage loans.

It is a further object of the invention to make use of Monte Carlo simulation tools to address uncertainty and volatility with respect to interest rate futures.

It is a further object of the invention to forward project financial behavior based on consumer mortgage loans, both current and alternative choices.

It is a further object of the invention to help a consumer monitor current loan performance against the interest rate market to determine refinance opportunities or when to prepay an existing loan.

It is a further object of the invention to present output views that are concise, maximize consumer disclosure, and are filtered according to client specified criteria in order to promote optimal decision making for the consumer client.

It is a further object of the invention to provide output in different media using popular formats such as world wide web (XML), Microsoft Excel (XLS), text (CSV, ASCII), Adobe (PDF) and common data streaming protocols (SOAP).

### SUMMARY OF THE INVENTION

In accordance with the present invention, there is provided a system that models and projects a wide set of loan offerings using a rigorously defined data schema, quantitative methods and algorithms combined into a consumer oriented mortgage DSS tool. This DSS tool projects future interest rate scenarios using statistical methods, relying upon Monte Carlo simulation techniques. It presents feasible and dominant mortgage loan options based on a concise expression of consumer supplied evaluation criteria and risk tolerance.

The tool's processing engine is open-architected to accept a consumer's financing need as input and then respond with a loan choice that satisfies consumer criteria, irrespective of the source or system that originates the request. Possible request sources are: a consumer making a request through a web-based edit screen of an independent, non-integrated system; an integrated calculator-like applet or widget that accepts the concise input from a user in a graphical presentation and returns the results through the same graphical mechanism; an electronic commerce system (Ecommerce) that issues a request that integrates results as part of a holistic or multiple domain financial planning system. Other sources of an inquiry to the consumer DSS system may exist through similarly adapted methods.

The system provides a set of prebuilt, standard loan classes (types) that mimic the behavior of the most popular, current loans found in the marketplace. Major classes of loan types include: 1) Conventional Fixed Rate Mortgage (FRM) loans of various term durations; 2) Hybrid Adjustable Rate Mortgage (ARM) loans of various fixed period durations; 3) Interest Only (I-O) loans for various periods followed by principal plus interest payment term durations; 4) Payment Option ARM loans allowing borrower to vary monthly payments based on several criteria.

Periodically, the parameters of these prebuilt loan classes are updated in conjunction with the changing market Terms and Conditions (e.g. changes in the market rates of various interest rate indices). These updates are expected to occur monthly but may occur as frequently as daily. Parameter updates for the invention typically occur as part of an automatic link to source data references.

The system also allows a consumer to define the Terms and Conditions of an existing loan thereby allowing calculation of what the monthly payment should be, in conjunction with changing interest rates.

Further the system allows a consumer to define criteria that specifies the limits (or preferences) a consumer may have with respect to meeting the loan obligations. These criteria define the constraints that any feasible solution must adhere to. Feasibility of the successful debt termination of the loan is then determined as a combined consideration of consumer limits, preferences, and net present value.

Further, the system identifies refinancing opportunities by comparing the projected performance of an existing loan against the suite of marketplace choices, while incorporating existing loan termination, prepayment penalty and new loan origination fees.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a high level process flow view of a consumer's typical use of the invention;

FIG. 2 is an architectural view of the invention's three primary building blocks of input, processing and output;

FIG. 3 is a data schema encapsulated view of the eligible loan set, loan, and segments that comprise a loan;

FIG. 4 is a logic flow view of an interest rate generator;

FIG. 5 is a logical flow diagram of a Scenario Processor that models the performance of a set of possible or eligible loans against consumer evaluation criteria and interest rate case scenarios;

FIG. 6 is a 3-dimensional view of an aggregation array that sums the results of specific combinations of initial loan and refinancing trials across a plurality of case scenarios;

FIG. 7 is a calculation of a specific loan and interest rate scenario, also known as case-loan analysis, to determine the projected monthly payment, balance, interest, and special one-time fees;

FIG. 8 is a calculation method view of a specific loan segment and interest rate scenario, also known as case-loan segment analysis, to determine the projected monthly payment, balance, and interest;

FIG. 9 is an example of the type of output possible resulting from a consumer's loan evaluation.

For purposes of clarity and brevity, like elements and components will bear the same designations and numbering throughout the Figures.

### DESCRIPTION OF THE PREFERRED EMBODIMENT

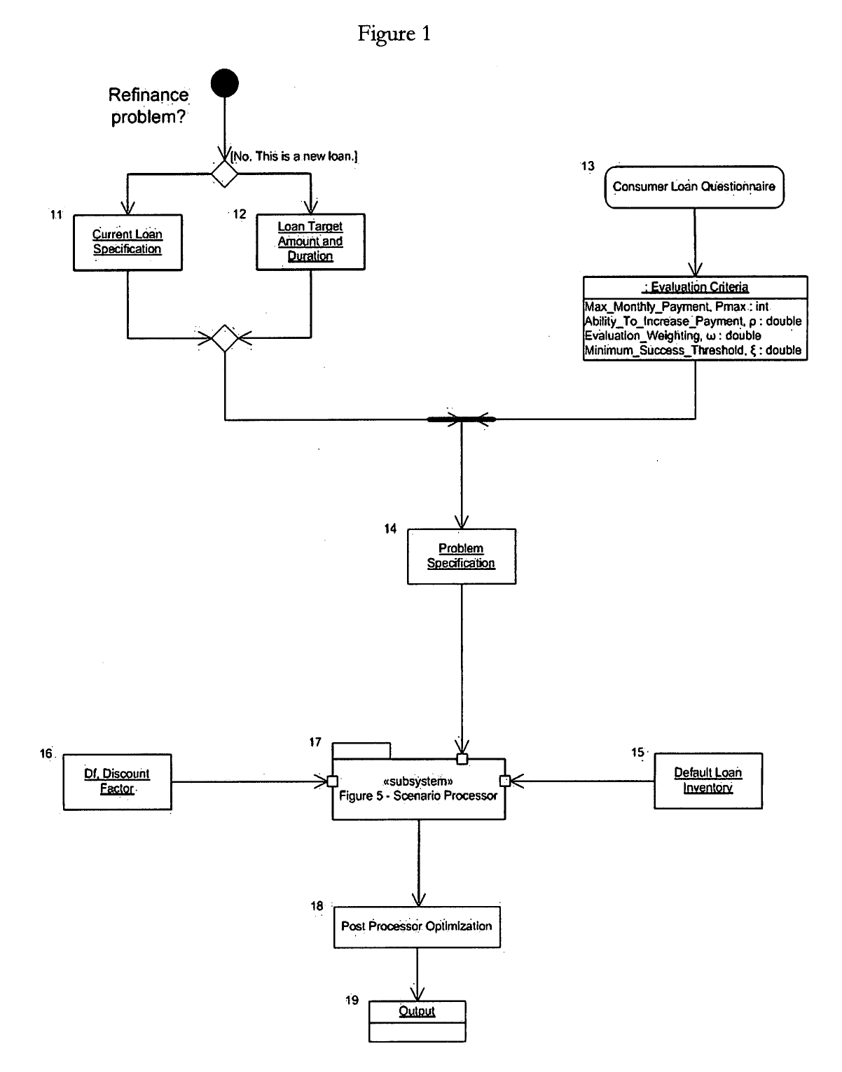

The main process flow to evaluate consumer loan selection is depicted in FIG. 1. Typically, a consumer may make several requests (a.k.a. “client requests”) in the search of an optimal mortgage loan strategy as a series of what-if analyses.

The first step in the process is for the consumer (the borrower) to specify the type of evaluation, whether the evaluation will be: (1) to compare a consumer's existing loan against competitive loan options—i.e. whether to refinance existing debt, hereinafter known as the “refinance problem” or (2) to select an initial loan, hereinafter known as the “initial loan problem”. For a refinance problem, the consumer needs to express the specifications of their current loan 11. For the initial loan problem, only the loan amount and expected duration need to be expressed 12.

In addition, criteria to evaluate loan options need to be established to determine which loan options, from a set of choices, is most compatible and preferable to a consumer's need. A series of questions are asked and mapped to a quantitative expression of evaluation criteria 13 referenced by the invention's methods. An example of such a series follows in Table 1 below:

TABLE 1

| Question | | Response Choices |
|---|---|---|
| 1. | What is the current maximum payment that you can | Maximum monthly payment in dollars |
| | afford to cover monthly principal and interest? | stated in present value terms |
| 2. | What is the expected duration of your financing need? | Number of years |
| 3. | What confidence level do you have in projecting your | Scale from 0-10, with 10 being the |
| | job security, income growth, and cost-of-living over | highest confidence. |
| | the course of the next 5 years? | |
| 4. | How do you expect your average annual income to | No income growth expected (0.0); Same |
| | grow relative to the cost-of-living? | growth as cost-of-living (1.0); One-half |
| | | cost of living (0.5); One-quarter cost-of- |
| | | living (0.25); Three-quarter cost of living |
| | | (0.75). |
| 5. | What annual percent increase could you allow your | 0%-50% |
| | current monthly mortgage payment to increase by? | |
| 6. | To what degree is it preferable to have a mortgage | Scale from 0-10, with 10 giving |
| | with constant payments compared to one with | exclusive weight to monthly payment |
| | fluctuating payments that might result in lower life | predictability; 0 gives exclusive weight to |
| | cycle costs? | minimizing life cycle costs. |

Answers to these questions above are mapped to quantitative evaluation expressions as Follows in Table 2 below, where R#n denotes the responses to questions of Table 1 :

TABLE 2
Evaluation Criteria

| Evaluation Criteria | Calculation |
|---|---|
| 1. Maximum monthly | R#1 |
| payment, Pₘₐₓ | |
| 2. Ability To Increase | e^{-c*R#2} × [(R#4 * κ) + (R#5/0.5) * |
| Payment, ρ | (1.0 − κ) * (0.1 * R#3)] |
| | where κ is % credence or weight given to |
| | question 4 and c is a constant for the decay |
| | function (e.g. 0.02) |
| 3. Minimum Success | 100% − (2% * R#3) |
| Threshold, ξ | |
| 4. Evaluation | 1.0 − (0.1 * R#6) |
| Weighting, ω | |

In Table 2, if ρ=0, the consumer has no ability to increase payments over time from the current stated maximum payment Pₘₐₓ. At the other extreme, ρ−1 signifies the consumer's ability to increase payments rises at the rate of inflation. Values in between signifies the ability to increase payments at a fractional rate to inflation. The minimum success threshold ξ is the percentage of simulated case runs that must succeed in order for a loan to be considered viable. Finally, the weighting ω compares loan solutions at a finer level of optimization granularity.

The problem specification 14 is the combination of the client financing need and evaluation criteria,

The default loan inventory 15 is a collection of the most common loan types available in the lending market. The inventory is periodically updated to reflect prevailing terms and conditions in a dynamic market. The consumer may be only eligible for a partial set of the loans in the default inventory, filtered based on his (or her) credit worthiness. Hereinafter, the partial set will be referred to as the eligible set. For the refinance problem, a consumer's existing loan will be added to the eligible set.

Only eligible loans will be considered for a particular client request. All loans m the eligible set will be treated as possible solution candidates. However, loan presence in the eligible set does not guarantee the loan's viability for the consumer as a loan may fail to meet the evaluation criteria as a result of the processing methods subsequently described in this invention.

A discount factor 16 D_{f} is derived using the current risk free rate, such as the return on a 10-year Treasury note as reported by the U.S. Treasury web-site using common methods (e.g. SOAP, XML) for electronic information exchange. Throughout many of the methods described herein, the discount factor is used to convert future values to present values to ensure comparisons are against a common dollar reference, specifically a dollar's worth known to the consumer today.

The problem statement 14, default loan inventory 15, and discount factor 16 are input to a Scenario Processor 17. Contained in this processor is Monte Carlo simulation, a primary method used to generate a plurality of interest rate case scenarios, hereinafter referred to as “case scenarios”. For each case scenario, the methods contained in the Scenario Processor project financial performance of each loan in the eligible set, measure the financial projections against the evaluation criteria, and record results in a collection of 3-dimensional statistical arrays for Post Processor Optimization 18.

The Output 19 is designed to enhance consumer's decision making capabilities.

### System Design and Architecture

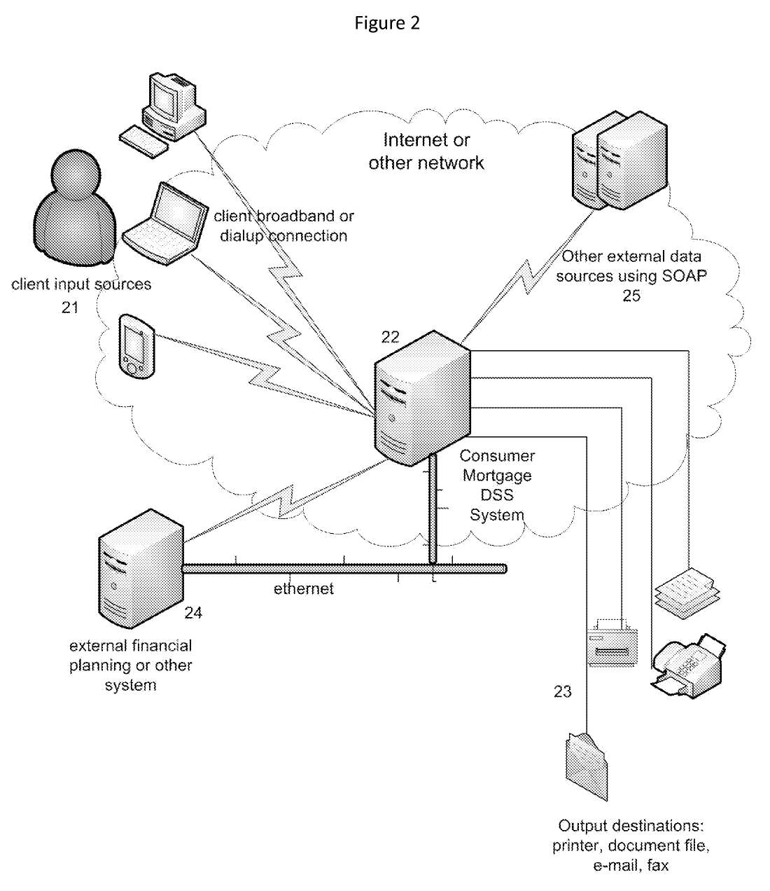

The essential elements of the invention as a deployed system are identified in FIG. 2. This diagram identities the input sources 21, Consumer Mortgage DSS system (the current invention) 22, embodied in the figure as a software computer program operating in a server computer on the Internet or other network, output destinations 23 for receiving the results of the DSS analysis and external financial planning systems 24. Input sources 21 may exist as manual data entry from a web browser, computer software or Personal Digital Assistant (PDA), or as data files in common formats such as eXtensible Markup Language (XML) or Microsoft Excel (XLS) are submitted over common data exchange protocols such as SOAP from an external financial planning system 24.

The invention does not discriminate between different input sources as long as the required data schema is adhered to as input criteria. Furthermore, the invention may exploit other external data sources 25 to provide frequent automatic updates to essential data such as current LIBOR lending rates or 30-year U.S. Treasury yields. These external data connections make use of common data networking protocols such as SOAP for data exchange. Input sources may be connected to the invention either directly via common networking mechanics and protocols such as Ethernet and TCP/IP, or indirectly through broadband or dialup connections to either private networks or the Internet. Output destinations may be the same as the input sources 21 for examples when the data is returned directly to the client's web browser or PDA. Alternately, output destinations may refer to common messaging and media formats such as printers, e-mail, fax or other documents 23.

While the input sources and output destinations are outside the scope of the invention, they are necessary to the discussion to provide examples of how users will interact with the analytical system. Such an example of the invention described exists on the Internet as provided under a rigorous development and research web site at www.financialmedic.info.

### Loan Data Schema

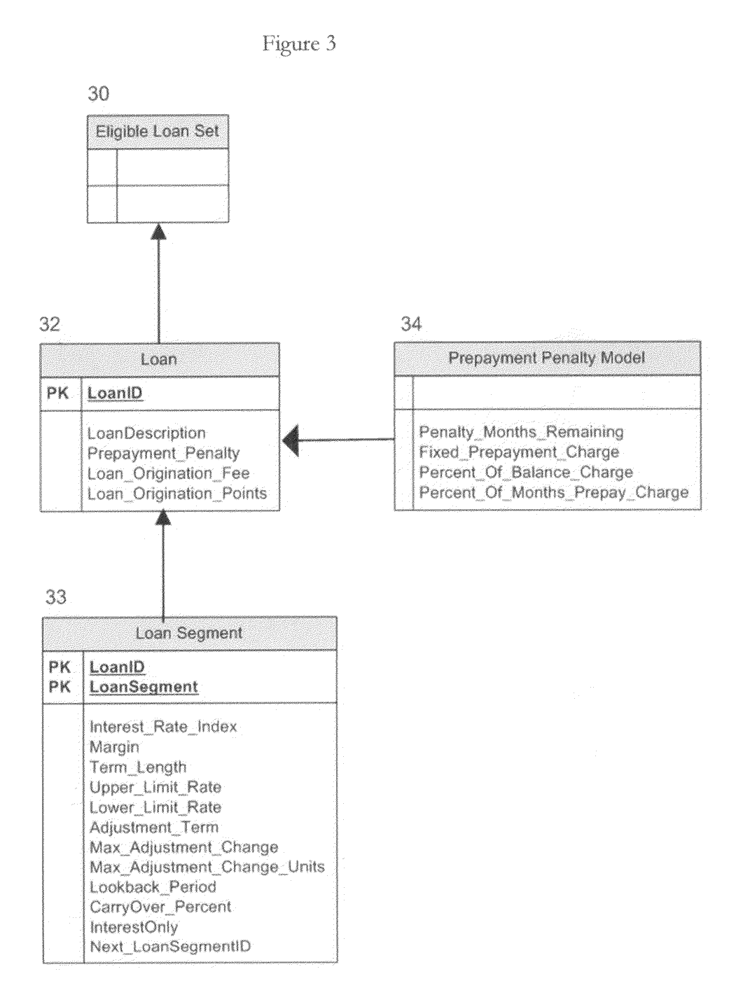

A data definition and organization, hereinafter referred to as a Loan Data Schema, is a prerequisite to project financial behavior of a variety of mortgage loans. Such a schema is described in FIG. 3, illustrated by a hierarchy of an eligible loan set 30, loan 32, and loan segment 33.

An eligible loan set 30 represents a collection of consumer loan alternatives. Loan properties include origination and termination transaction costs. Origination costs are specified as in Table 3 below.

TABLE 3
Origination Cost

| Element | Definition |
|---|---|
| Loan_Origination_Fee | A fixed cost to originate the loan. |
| Loan_Origination_Points | A variable cost to originate the loan, as a |
| | percentage of the loan balance. |

For the refinance problem, a consumer's may have already incurred origination fees. As sunk costs, these fees are ignored in the calculation of a loan's net present value for purpose of evaluation. A loan's termination cost 34 can be expressed in terms as in Table 4 below.

TABLE 4
Loan Termination Cost

| Element | Definition |
|---|---|
| Penalty_Months_Remaining | A penalty phase that defines |
| | the number of months remaining |
| | on a loan that would trigger a |
| | penalty in the event the loan |
| | is fully paid before its |
| | contractual minimum |
| | term. |
| Fixed_Prepayment_Charge | A fixed dollar amount, |
| | applied at the time of |
| | loan termination should |
| | the loan be terminated |
| | during the penalty phase. |
| Percent_Of_Balance_Charge | A calculated dollar |
| | amount as a percentage |
| | of the loan's remaining |
| | balance, applied should |
| | the loan be terminated |
| | during the penalty phase. |
| Percent_Of_Months_Prepay_Charge | A penalty in the |
| | amount of this percentage |
| | multiplied by the loan's |
| | remaining balance |
| | multiplied by the months |
| | paid earlier than the |
| | months remaining. |

A loan 32 is further described by inheritance of the properties of one or more loan segments {σ₁, σ₂, . . . , σₛ}. A segment defines the properties of a loan that characterizes financial behavior for a specified interval of time. It is not uncommon for loans to be multi-segment in the lending environment. For example, an exotic hybrid loan may have as many as three segments, which may include two tiers of short duration loan segments (often known in the industry as “teaser loans”) followed by a longer duration (“post-teaser”) segment. The data schema imposes no theoretical limit on the number of possible loan segments.

A loan segment 33 is defined by the following data elements as in Table 5 below.

TABLE 5
Segment Definition

| Element | Definition |
|---|---|
| LoanID | A data key to tie a loan segment to a specific loan. |
| LoanSegmentID | Identifies a specific loan segment. For example, a two-step hybrid has two |
| | segments, typically starting out as a fixed rate loan σ₁ and then converting to |
| | an adjustable rate loan σ₂ for the remaining life. |
| Interest_Rate_Index (IRI) | Describes a segment's relationship to a specific interest rate index (IRI). The |
| | index is one of several elements that determine the applicable interest rate |
| | used in calculating the interest payment a consumer is charged. Common |
| | indices are 30 year bond; 10 year note; LIBOR; COFI. |
| Margin | Identifies a percent displacement relative to IRI used to derive the applicable |
| | interest rate. For example, a consumer's applicable interest rate might be |
| | 2.0% above “LIBOR 3 Month”. “LIBOR 3 Month” defines the IRI. Margin |
| | is 2%. |
| Term_Length | Identifies duration of this segment's loan terms in months. For example, a |
| | two-step hybrid may have an initial term of 36 months for σ₁ before |
| | converting to the Terms & Conditions of the remaining term (e.g. 324 |
| | months) described by σ₂. |
| Upper_Limit_Rate | Defines maximum applicable interest rate possible for this segment. |
| Lower_Limit_Rate | Defines minimum applicable interest rate possible for this segment. |
| Adjustment_Term | If the interest rate is adjustable, this entry defines the frequency in which the |
| | consumer's applicable interest rate is adjusted based on changes in the |
| | underlying IRI. Example: 6 months would mean that the applicable interest |
| | rates adjust every six months. |
| Max_Adjustment_Change | Identifies the maximum absolute applicable interest rate adjustment, either |
| | as an absolute percentage change or as a percentage change relative to the |
| | current interest rate. The Max_Adjustment_Change_Units property |
| | identifies whether the change is in absolute or relative terms. |
| Max_Adjustment_Change_Units | Either absolute change or percentage change of the applicable interest rate. |
| | Relevant only if the interest rate is adjustable. |
| Lookback_Period | Identifies in the number of days the date used to reference the adjusted |
| | interest rate (LIBOR, etc.). For example, if the Adjustment_Term is 6 |
| | months on October 1st and the Lookback Period is 45 days, the LIBOR rate |
| | referenced for the adjusted IRI would be August 17th. |
| CarryOver_Percent | If this is a multi-segment loan, the percent balance which will be carried |
| | forward to the next segment at the end of this segment. If the loan is single- |
| | segment or if the carryover is less than 100%, all or part of the non-carried |
| | over balance is due at the end of the segment's term as a balloon payment. |
| InterestOnly | Set to true, if this segment requires that a consumer is only obligated to |
| | make an interest payment during the course of this segment. |
| Next_LoanSegmentID | If this is a multi-segment loan, this field points to the next segment for the |
| | same loan ID. |

Typical loans structures that can be modeled by this Loan Data Schema are:
(1) One-segment fixed conventional, typically 15-year, 20-year, or 30-year term;
(2) Hybrid ARM, typically a two-segment loan where initial segment has a fixed interest for some period (2, 3, 5, 7, or 10 years) followed by an adjustable rate every year for the remainder of the loan (28, 27, 25, 23, or 20 years). Borrower pays both principal and interest throughout both segments.
(3) Interest Only (I-O), typically a two-segment loan where borrower pays only interest on the loan for an agreed term, typically between 3 and 10 years. During this period the interest rate may be adjusted on 6- or 12-month, cycles, depending on the loan terms. The remaining years require interest plus principal payments until loan termination.
(4) Payment Option ARM allows borrower to choose between a variety of payment options each month with typical choices including: a) interest only; b) principal plus interest; c) minimum payment which may be less than interest only. Payment recalculations occur on some interval such as every 5 years.

The Loan Data Schema allows numerous variants and sub-variants of these typical loan structures.

### Interest Rate Scenario

Except for traditional, fixed interest loan products, financial performance of many loans depends on future interest rate behavior. The invention generates interest rate scenarios using Monte Carlo methods to address the stochastic nature of interest rate volatility. Loans in the eligible loan set are modeled against interest rate scenarios. The number of case scenarios generated is at the discretion of the implementer to conform to standard statistical guidelines used in experimental design. For example, this might be 1,000 cases. Hereinafter, M-cases refers to the number of interest rate scenarios generated per client request.

Let \vec{Ψ^{x}} denote a vector of Interest Rates across the financing need duration (K-months) for a specific interest, rate index (IRI) defined in the eligible set, where x ε {10 or 30 year Treasury, LIBOR 3 month, COFI}. \vec{Ψ^{x}} is a base reference to determine the applicable interest rate charged to consumers on a loan whose Interest Rate Index (IRI) is x. It is only a base reference since the applicable interest rate charged to a consumer loan also depends on other loan terms such as margin, interest rate caps or limits. Let \vec{Ψₖ^{x}} denote a specific vector element of \vec{Ψ^{x}} that represents a specific IRI in the k^{th} month, where k ε [0 . . . K].

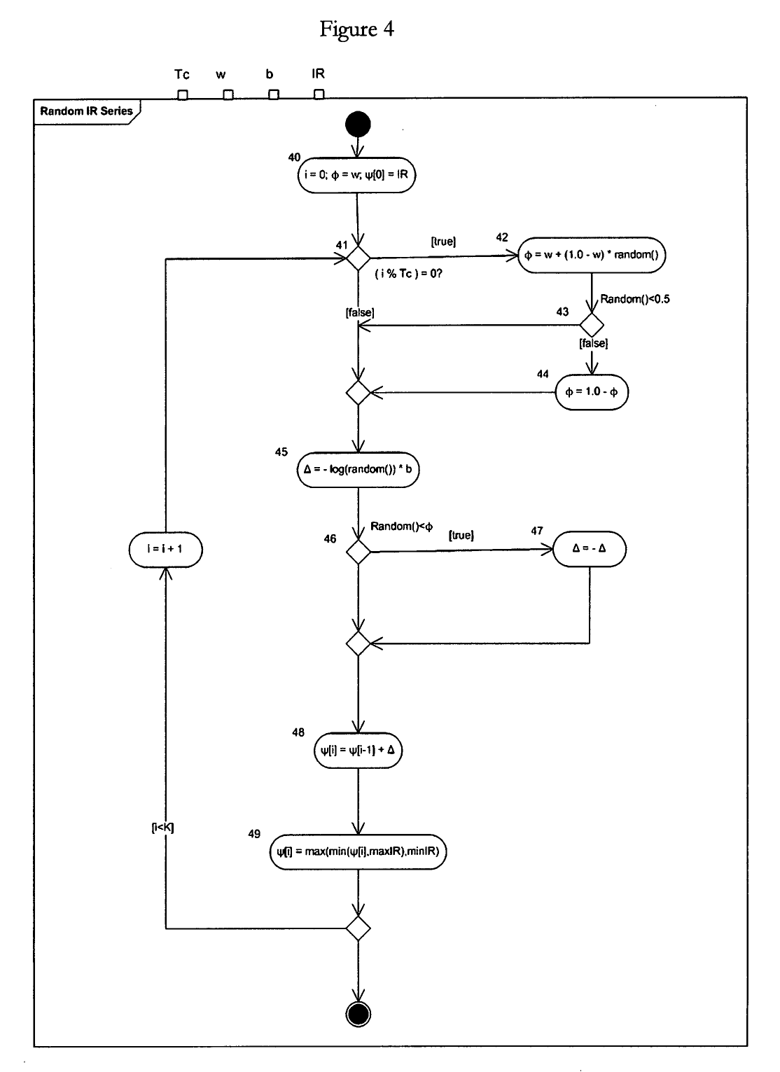

FIG. 4 illustrates a generalized IRI scenario generator. Each call to the generator produces \vec{Ψ^{x}} using input parameters unique to a specific IRI (e.g. LIBOR 3 month) being produced. As an example, the behavior of LIBOR 3 month can be approximately modeled by setting four parameters identified below to w=0.85, b=0.00155, and T_{c}=24 (or as an implementer wishes to override): (1) T_{c}, a cycle period, that defines the periodicity of an interest rate change bias (e.g. 24 months), (2) W, the change bias, a value of [0.5, 1.0), that controls whether directional change in interest, rate trending is random or auto-correlated, (3) b, the mean absolute value of the monthly interest rate change, (4) IR(x), the current interest rate for index rate index, x, and (5) K, the number of interest rate periods to be generated.

Upon initialization 40, the first entry in the interest rate vector is set equal to the current interest rate, Ψ₀^{x}=IR(x). φ, known as the dynamic bias comparator, is set equal to W. The process loop 41-49 builds the remaining entries in Ψ^{x} by iterating t ε [1 . . . K]. For each t, a decision is made to determine whether a new bias cycle is starting 41. If a new bias cycle has started, φ is recalculated 42. In the special case where the cycle period T_{c}>K, φ would never be recalculated from its initiated value w, such as would be appropriate for fixed interest rate loans. For example, if W=0.5 and T_{c}>K, the interest rate generator begins and ends with a neutral directional bias. Incidentally, W=0.5 mimics the case of pure Brownian motion.

In the general case, φ is recalculated by adding W to a random value in the fractional space not covered by W 42. The calculation will derive a value φ in the range [W, 1.0]. As a final step, another random variable [0, 1.0] is drawn 43. If this random variable is less than 0.5, then φ=1.0−φ 44. These steps ensure φ ε [0, 1.0−W] ∪ [W, 1.0] creating a gap in the range of [1.0−w, W] when W>0.5.

The interest rate change magnitude Δ is calculated by multiplying b, the mean variation for the IRI, by a random draw from the exponential distribution 45. The applied change is positive or negative depending on the choice of another random variable relative to the comparator 46. If the new random variable is less than the comparator the change is a downward move of the interest rate base reference, that is Δ=−Δ0 47. Interest rate Ψₖ^{x} will be the prior period's interest rate affected by Δor Ψₖ₋₁^{x}=Ψₖ₋₁^{x}+Δ 48. All interest rate changes may be bound by upper and lower limits 49. This process is repeated ∀t to derive \vec{Ψ^{x}}.

### Scenario Processor

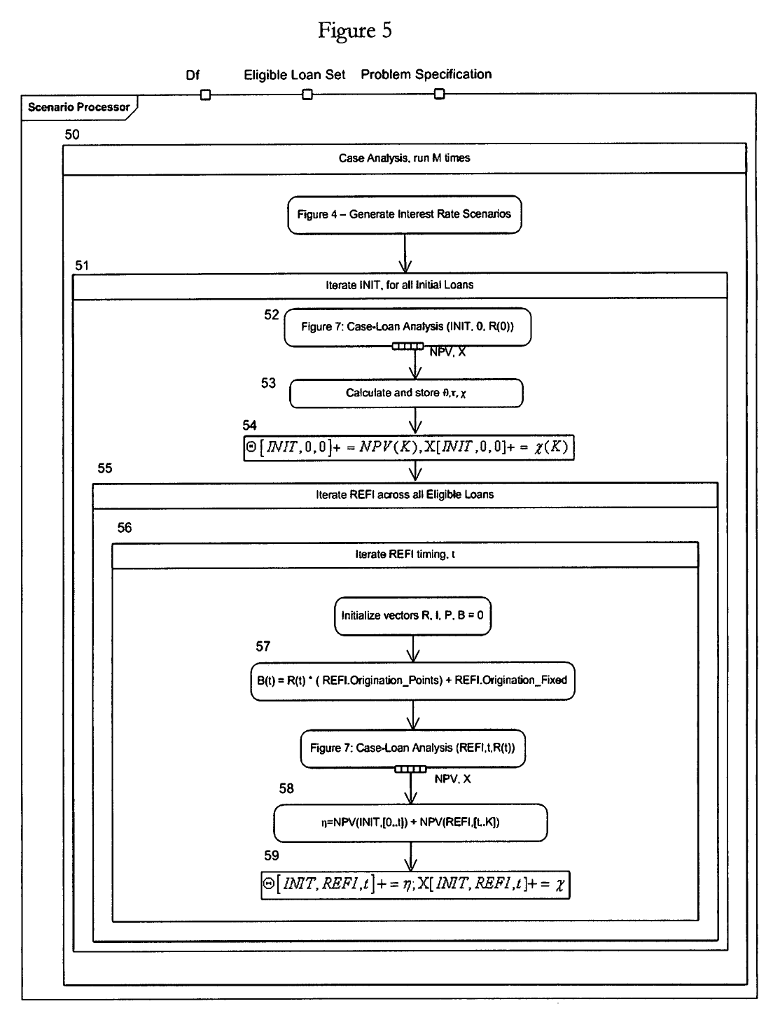

FIG. 5 describes a scenario processor. The processor's primary function is to run M case scenarios, evaluate the performance of initial and refinance loan choices against the case scenarios, tally the runs for each trial case, and update a statistical array that is referenced during post-processing method 18.

Four concentric iterative loops are illustrated in FIG. 5: (1) an M-loop 50, where in each instance, an interest rate scenario Ψ is generated in accordance with the method described in Interest Rate Scenario, (2) an Initial Loan (INIT) loop 51, (3) a Refinance Loan (REFI) loop 55, and (4) a REFI timing loop 56.

The INIT loop 51 iterates across Initial Loan (INIT) possibilities. For a refinance problem, the consumer has an existing loan, thus the INIT loan is a given (singleton). For the initial loan problem, the INIT is not a given and the INIT loop iterates across all members of the eligible set. In either the refinance or initial loan problem case, the REFI loop 55 iterates across all members in the eligible set. The REFI timing loop 56 completes the specification of a hypothetical or “trial” option—i.e. the evaluation of an INIT loan held to a future time t upon which the loan terms convert to the REFI loan. In the initial loan problem, the primary optimization focus is the INIT loan whereas in a refinance problem, the Refinance Loan (REFI) and its timing are the primary focus of optimization.

For each interest rate scenario generated by the Monte Carlo process, the scenario processor iterates across combinations or trials of INIT, REFI and refinance times. The REFI null (a.k.a. “do not refinance”) option is also considered. The REFI null option is one where the INIT is maintained during the client's full period of financing need. Only when a REFI is being considered is the refinancing timing an issue. Whereas the decision point for a new loan is always the current month t=0, a REFI decision can include all months spanning t ε [t₁ . . . K-1]. The innermost block 56 projects the financial performance of a trial combination—i.e. to refinance an INIT loan to a specific REFI loan at a specific time for a single simulated case of interest rate volatility.

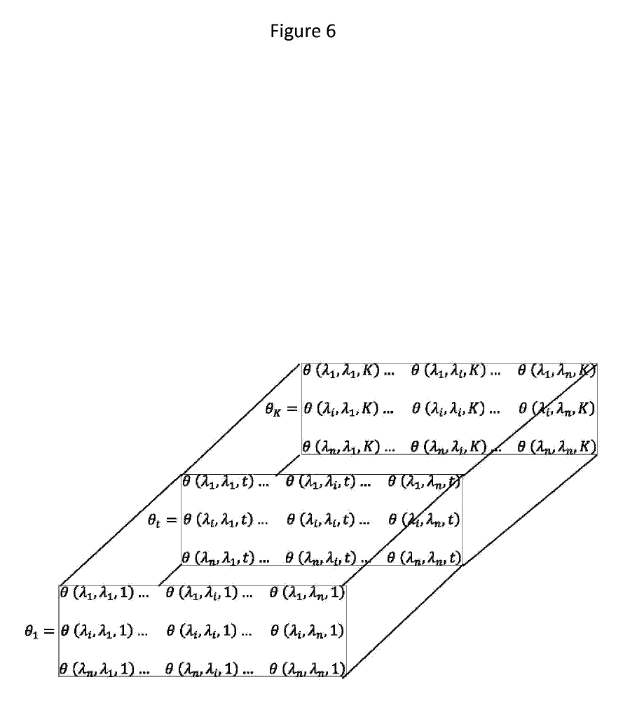

Results from trial combinations are updated in 3-dimensional aggregation arrays, Θ and X, both of which sum the results of each trial in an array slot. FIG. 6 depicts Θ, but illustrates the dimensionality of both Θ and X. Θ is known as the net present value (NPV) aggregation array. Slot θ (λᵢ, λⱼ, t) refers to INIT loan λᵢ followed by a REFI loan λⱼ where refinancing occurs during month t. X is the aggregated success array where trial successes are summed. By convention, slot (λᵢ, 0,0), not shown in FIG. 6, is used to record null REFI option for INIT loan λᵢ.

### Singular Loan Calculation Methodology

The following discusses the calculations necessary the foundational steps to perform a financial projection under an interest rate case scenario \vec{Ψ} for a single INIT loan with the null REFI option 52. The steps to perform a generalized financial projection that involve a REFI will be described once all dependent foundational steps are first, described.

Financial projection refers to the calculation of vectors \vec{P}, \vec{R}, \vec{I}, and \vec{B} across a client's financing need interval k ε [0 . . . K] for a given loan L where: (1) \vec{R} is a vector of Loan Balances and Rₖ denotes the Remaining Loan Balance in the k^{th} month. R₀ is defined as the current balance of an existing loan or a requested loan amount, (2) \vec{I} is a vector of interest payments and Iₖ denotes the interest payment in the k^{th} month, (3) \vec{P} is a vector of loan payments and Pₖ denotes the required future value of principal plus interest payment in the k^{th} month, and (4) \vec{B} is a vector of one-time special payments, which may include balloon payments, origination or termination fees. Bₖ denotes the value of such payments in the k^{th} month.

The method begins by initializing the four vectors \vec{P}, \vec{R}, \vec{I}, and \vec{B} to \vec{0} where \vec{0} represents a vector where all elements are set to $0.

Origination fees, if not sunk costs, are calculated for the loan and set in B₀ per definition of Table 3.

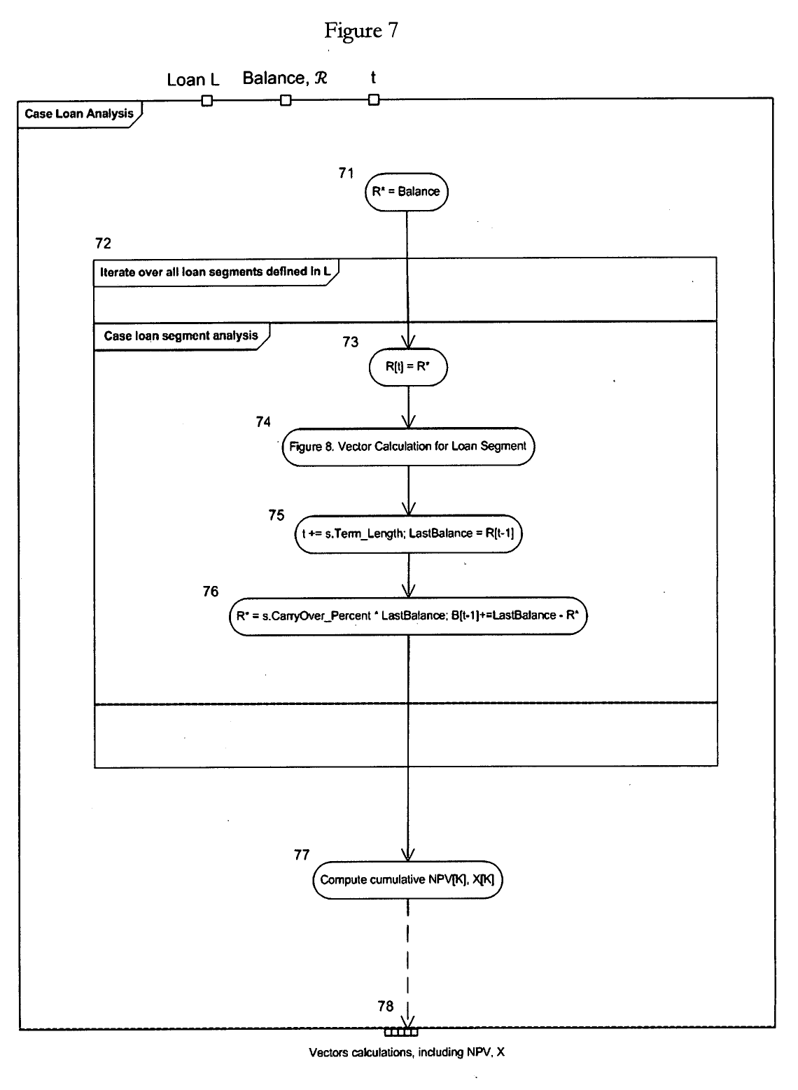

FIG. 7 describes the method used to process a loan consisting of one or more segments. The method in FIG. 7 is known as Case Loan Analysis, a method generalized to derive financial performance of a either an initial loan or refinance that takes place at some arbitrary time in the future. The method accepts three parameters: (1) the Loan to be analyzed, (2) t, the time to start the loan analysis, which may be current (i.e. t=0) or future month (i,e. t>0), and (3) the loan balance R at time t. In the case of an INIT loan, the analysis starts assuming the current month (i.e. t=0) 52.

The first step for any Case Loan Analysis is to set the current carryover loan balance R 71. For an INIT loan at time t₀ R=R₀, the client's current loan balance is the carryover loan balance. As earlier described m Loan Data Schema (FIG. 3), a loan may have one or more loan segments, each of which defines the loan properties for a specific term length. Each loan segment is processed in sequence 72 in accordance with the case-loan-segment processor block 73-76. The first step in this processing block 73 is to set this segment's starting loan balance to the carryover balance.

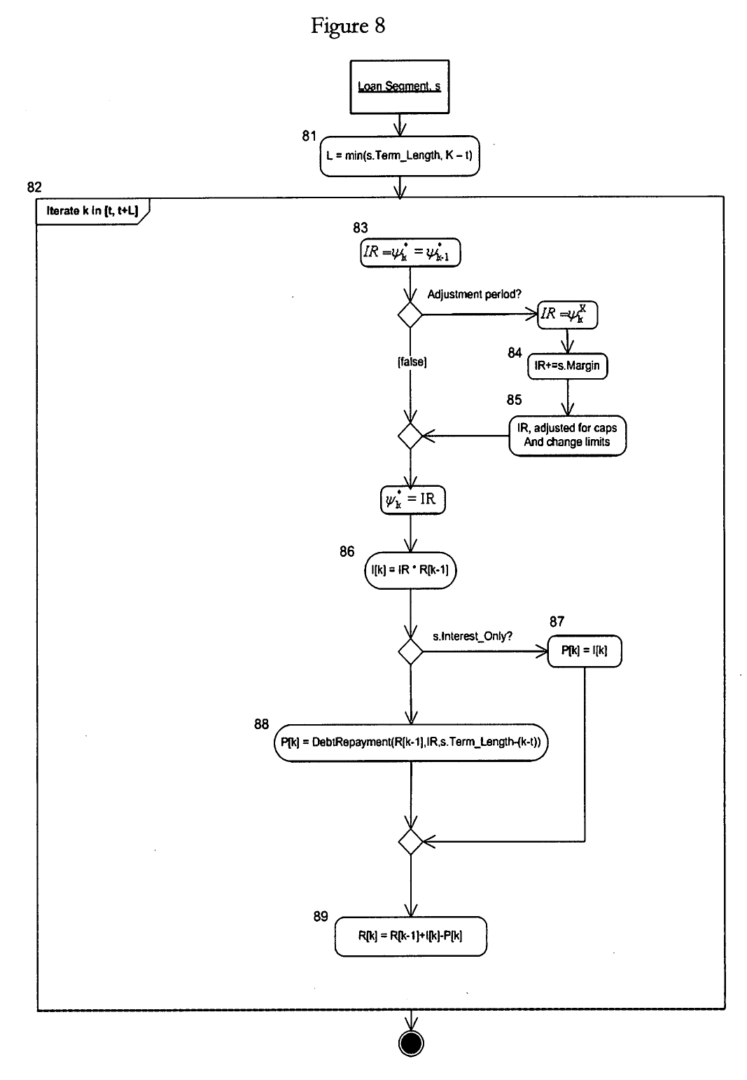

The financial performance of each segment σ₁ is analyzed according to the case-loan-segment processor 74. The vector calculations for a specific loan segment are described in FIG. 8. Input to FIG. 8 is the loan segment being analyzed and the starting time for the analysis of the segment. For those months covered by the current loan segment being analyzed (and only those months), the vectors \vec{P}, \vec{R}, and \vec{I} are updated to reflect total payment (i.e. principal and interest), balance, and interest rate payments, respectively. The number of months to be calculated 81 depends on the term length of σ₁ but it cannot exceed the remaining term of the consuitier's financing need K.

For each time iteration t 82, the first step is to derive the applicable monthly interest rate Ψ*ₖrequired to calculate the interest rate charge against the consumer's prior loan balance, Rₖ₋₁. The applicable monthly interest rate Ψ*ₖ inherits the interest rate applied to the client's loan of the prior month, Ψ*ₖ₋₁ 83.

If the applicable monthly interest rate adjusts during this period based on σᵢ properties described in Table 5, then Ψ*ₖ must be modified: (1) the first adjustment is the sum of the index rate index and the σᵢ segment's margin 84, Ψ*ₖ=Ψₖ^{x}+σᵢ. Margin and (2) Ψ*ₖ is further adjusted 85 by: (1) Rate caps (i.e. Ψ*ₖ≦σᵢ.Upper_Limit_Rate), (2) Rate minimums (i.e. Ψ*ₖ≧σᵢ.Lower_LimitRate), and (3) Rate changes (i.e. Ψ*ₖ≦Ψ*ₖ₋₁+σᵢ.Max_Adjustment_Change).

Once the annualized Ψ*ₖ is established, it is converted to a monthly interest rate. The interest charge for the k^{th} month is calculated 86 according to Iₖ=Ψ*ₖ*Rₖ₋₁.

If σᵢ is interest only 87 the payment is equal to the interest charge, Pₖ=Iₖ, otherwise the payment includes a principal charge, Pₖ=(Ψ*ₖ*Rₖ₋₁)*(1.0+1.0/((1.0+Ψ*ₖ)^{D}−1.0 )) where D is the remaining duration, expressed as the number of months, to repay principal 88.

Finally, the remaining balance is calculated Rₖ=Rₖ₋₁+Pₖ−Iₖ 89.

When the case-loan-segment method has completed its calculations for a specific loan segment's Term Length, the case-loan analysis method resumes by adjusting its time pointer t to reflect the end of the current segment just processed 75. For example, σ₁ defines behavior for the time span from t₀ to σ₁'s Term_Length. A second loan segment σ₂, presuming one is defined for the current loan being analysed, covers an additional time span as defined by its Term_Length. The accumulated time covered by any σᵢ is Tᵢ=Σⱼ₌₁ⁱ=1(σⱼ.Term_Length) subject to Tᵢ≦K. If a loan has only one segment (σ₁), its properties defines the loan's financial behavior over the entire consumer's financing duration, K.

The final balance of the segment may be carried over m whole, in part or not at all, depending on a segment's carryover percentage 76 defined in Table 5. For any i>1, the carry-over balance is determined by [symbol] =(R_{Ti-1}* σᵢ₋₁.CarryOver%). Any balance not carried over is recorded in B_{Ti-1} and treated as a one-time balloon payment. If [symbol] =0, the loan has been fully paid and no further calculations are required for the remaining months of the loan. If the current loan segment is the last loan segment then any remaining balance becomes a balloon payment.

A loan is completely processed when either: (1) all loan segments have been analyzed, or (2) [symbol] =0, or (3) k≧K. When any one of these three conditions is met, vectors \vec{P}, \vec{R}, \vec{B} and \vec{I} reflect the results for this case-loan analysis under the current interest rate case scenario.

### Tallying Performance Statistics

Results of the net present value (NPV) and success results are then computed 77. NPV is determined from Σᵢ₌₀^{K}(Pᵢ+Bᵢ)/(1.0+Df)ⁱ.

To measure whether a trial combination of INIT, REFI, and refinance time is successful for a given interest rate scenario, the client's monthly payments are adjusted according to P*ₖ=Pₖ/Dfₖ where

$${Df}_{k} = {( 1.0 + ( \frac{{D}_{f}}{12.0} ) * ρ )}^{k} ∀ k ε [ 1 … K ] .$$

Derived from the responses from the consumer loan questionnaire as described in Table 2, ρ defines a consumer's ability to increase loan payments over time.

A trial combination is successful if for \vec{Ψ} all P*ₖ≦Pₘₐₓ, ∀k of K where Pₘₐₓ is the upper bound in present value terms that the consumer can honor throughout the loan duration as defined in Table 2. That is, for a given interest rate scenario, the required loan payments must never exceed the client's ability to pay during the entire course of a loan.

To support the methods contained within the inner REFI loop 55, three additional vectors store the result of the INIT loan calculation 53. They are: (1) [symbol] (t)=Σᵢ₌₀^{t}(Pᵢ+Bᵢ)/(1.0+Df)ⁱ, the projected net present value of an INIT loan from the present time to the future time t under \vec{Ψ}, (2) τ(t)=Rₜ, the projected balance of an INIT loan at the future time t under \vec{Ψ}, and (3) χ(t)=1, if the loan is successful for all periods up to time t, otherwise 0.

Summed in the aggregation arrays 54 are, where I is a singular INIT loan being analyzed: (1) Θ(I,0,0)=Θ(I,0,0)+ [symbol] (K), and (2) X(I,0,0)=X(I,0,0)+χ(K), where χ(K)= 1 if the INIT loan without refinance is deemed successful across the entire financing duration.

REFI Loan Calculations for a given INIT

The scenario processor proceeds to calculate refinancing alternatives for the same \vec{Ψ} and INIT loan I by iterating over the REFI loop 55. In the following discussion, let loan J be a specific REFI loan. A refinance calculation also requires the specification of a refinance at a future time t. A REFI loan calculation is designed to yield the expected financial behavior of having an INIT loan I for a period up to time t, converting to the REFI loan J at time t and retaining that loan until the end of the financing need.

The REFI loan calculation references vectors [symbol] (t), τ(t), and χ(t) since the net financial projection is dependent upon the INIT loan projection up to the trial refinancing time, t. The REFI calculation 57 addresses loan performance beyond time t and is similar to the Singular Loan Calculation methodology with the following variations: (1) the REFI calculations begin at trial time t>0, hence the vector elements preceding t in the REFI vectors \vec{P}, \vec{R}, \vec{I}, and \vec{B} remain at their initialized state of $0, (2) the initial balance of the REFI loan at time t, Rₜ inherits the balance of the INIT loan at time t, namely τ(t) as defined previously, (3) the interest, rates that apply to the REFI loan are those in effect, at, time t, i.e. \vec{Ψ}ₜ. For example, a refinance to a conventional, fixed mortgage at future time t is based on the simulated rate for the conventional fixed mortgage at time t (as apposed to the current time t₀), (4) loan origination fees are added at time t into Bₜ, (5) for a refinance problem, applicable INIT loan termination fees are added into Bₜ, (6) if INIT loan is unsuccessful at time t, namely χ(t)=0, then χ(k)=0 for k≧t. In other words, this INIT-REFI-time t trial can never be successful if the INIT loan was unsuccessful up to time t.

Let η, the projected net present value for this trial= [symbol] (t)+Σᵢ₌ₜ^{K}(Pᵢ+Bᵢ)/(1.0+Df)ⁱ 58.

The statistical aggregation arrays are updated 59: (1) Θ(I,J,t)=Θ(I,J,t)+η and (2) X(I,J,t)=X(I,J,t)+χ(K). Note that it is possible for an INIT loan to be successful for a limited time t [symbol] P*ₖ≦Pₘₐₓ, ∀k≦t. Such a limited success loan may be useful if a REFI loan can successfully cover the remaining time of a client's financing need.

The scenario processor completes upon full execution of all loops. For 1,000 interest rate scenarios, 5 loans in the eligible set, and 40 quarterly refinancing decisions, the total number of trials would include 1,000×5 (INIT)×5 (REFI)×40 or 1,000,000 total trials. Each Θ(I,J,t) cell entry would retain the sum of 1,000 trials. It is possible to re scale and minimize the number of trials using various reduction techniques, such as benchmarking performance results after completing a number of case runs and fathoming those INIT, REFI, and timing combinations that fail to meet minimum success thresholds.

### Post Processor Optimization

Optimal decision making requires a method to process the Θ and X output arrays, as described below.

First, array element, θ(i,j,t) and χ(i,j,t) in Θ and X are normalized through a scalar division of M cases to derive average NPV and success rates per trial. For example, χ(i,j,t) then becomes the average success rate of an INIT loan with a REFI attune t. χ(i,0,0) is the success rate of an INIT loan without a REFI. Success rates below ξ, the minimum success threshold as defined by Table 3, are fathomed—i.e. excluded from further consideration.

Secondly, the NPV metric is further normalized by defining

$$ζ ( i , j , t ) = \frac{Original Loan Balance}{\vert θ ( i , j , t ) \vert} ,$$

where θ(i,j,t)≠0.

Consumer favorable results are achieved with greater success rates and greater adjusted NPV. The optimal objective function becomes one of maximizing the product of success rates and adjusted NPV according to ω ε [0.0,1.0], the evaluation weighting criteria as defined by Table 2.

Two optimization objectives are: (1) determine the best single INIT, REFI, and timing decision. This involves finding the best combination i*,j*,t* that maximizes ζ(i*,j*,t*)^{2.0}*^{w}*χi*,j*,t*)^{2.0}*^{(1.0-w)} and (2) determine the best INIT, REFI irrespective of the specific time. This involves finding the best i*,j* combination that maximizes Σₜ₌₁^{K-}ζ(i*,j*,t)^{2.0}*^{w}*χ(i*,j*,t)^{2.0}*^{(1.0-w)}.

By convention, if t*=0, the best option is an INIT for the complete duration of the financing need. In a refinance problem, the methods previously described apply. In the latter case, the method is simplified by virtue of a constrained, singular i* the given INIT loan.

### Output

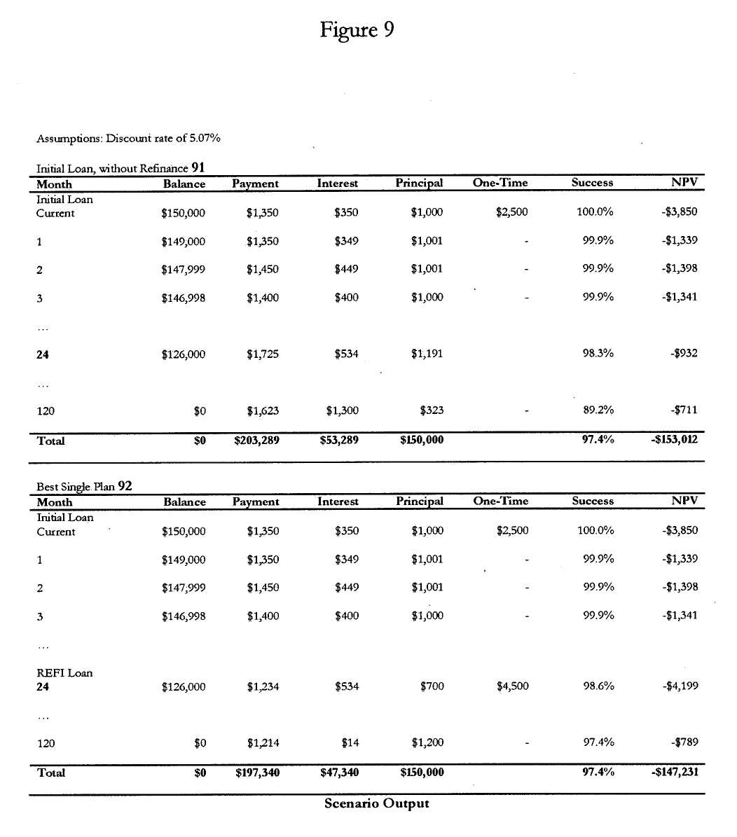

An example of the type of output from an evaluation, is illustrated in FIG. 9. The method is designed to yield the following information to the consumer:

Description and average results of an INITIAL Loan 91, under the assumption that the loan is never refinanced: (1) the success probability of the Initial Loan, and (2) the projected NPV of the current loan.

Description and average results of an INITIAL Loan 92, allowing for optimum time mortgage refinancing: (1) the average success probability of the Initial and REFI loan combination, and (2) the average projected NPV of the Initial and REFI loan combination.

The output illustration is only one example of the type and form of output. The full output arrays, Θ and X, or a. reduction could be packaged as part of standardized XML, CSV or other format for processing by other systems and methods external to this invention.

In the event no loan is determined feasible against the consumer's evaluation criteria, an implementation might respond by proposing a reduced loan request amount that would be feasible. This might involve the use of common optimization technique such as gradient descent, a slight variation of the FIG. 1 process. Since other modifications and changes varied to fit particular operating requirements and environments will be apparent to those skilled in the art, the invention is not considered to be limited to the example chosen for purposes of disclosure, and covers all changes and modifications which do not constitute departures from the true spirit and scope of this invention.

Having thus described the invention, what is desired to be protected from Letters Patent is presented in the subsequently appended Claims.

1. A method to fully describe the data schema and relational database structure including all critical attributes, common to all lender forms of consumer home mortgage loans as a fundamental basis for consumer home mortgage loan disclosure and mathematical modeling integrity containing:
a means to describe said relational database structure elements as a fully reduced and non-redundant, normalized data specification;
a means to parameterize and describe the four major abstract classes of home loans available to all consumers as one of: conventional fixed mortgages; hybrid adjustable rate mortgages (ARM); interest only mortgages; and payment option ARMs; thereby constituting a loan inventory;
a means to apply a multi-segmented type of definition to home loan mortgages where said definition permits changes to any given loan's specification over different time periods which affect the loan's financial behavior.

2. A method for the consumer client to fully describe their financing goals, constraints preferences and loan selection criteria as a Consumer Questionnaire where said questionnaire is complete and conforming to the consumer's description comprising:
a means to describe the consumer's current maximum payment affordable to cover monthly principal and interest;
a means to describe the consumer's expected duration of the financing need of the mortgaged asset rather than tied to the contractual duration specified of any one mortgage loan;
a means to describe the consumer's confidence level of job security, income growth and cost-of-living over the said expected financing need duration;
a means to describe the consumer's expectation of average annual income growth relative to the cost-of-living;
a means to describe the consumer's maximum annual percentage increase limits of monthly mortgage payments without creating financial hardship;
a means to describe the consumer's preference to engage in a mortgage loan with constant payments compared to one with fluctuating payments.

3. A method to create a standardized, comprehensive and rigorous consumer Problem Specification as input to the invention's consumer loan analysis where said specification is the combination of the said Consumer Questionnaire, Loan Inventory and a Discount Rate (defined below) such that said inputs are then used to seek the most effective mortgage debt strategy solution where said specification contains:
a means for describing a Default Loan Inventory as a set of loan candidates;
a means of then filtering said Default Loan Inventory into an Eligible Loan set using the results from the Consumer Questionnaire;
a means for deriving a Discount Rate using a risk free interest rate such as the return on a 10-year Treasury Note where said Discount Rate is used to convert future US dollar values to present US dollar values;
a means for combining said Problem Specification, Eligible Loans and Discount Rate for input to the invention's Scenario Processor.

4. A method of generating a plurality of Interest Rate Case Scenarios using Monte Carlo simulation for various common Interest Rate indices used as the basis for home mortgage loan interest rates, such that said Interest Rate Scenario is not bound to any historical model of data to model the unpredictable, volatile, and possible chaotic behavior of interest rates.

5. A method to generate and process a plurality of said Eligible Loans as a Scenario Processor where said Scenario Processor uses said Interest Rate Scenarios to project the financial performance of each said Eligible Loan candidate whereby the results of said projections are then recorded in a statistical 3-dimensionsal array for later Post Processor Optimization containing:
a means to iterate and permute across all said Eligible Loans and hypothetical refinance scenarios to mimic and model consumer decision making over the consumer's financing need duration;
a means to apply the results of said Interest Rate Generator to the contractual specifications of any Eligible Loan to determine concrete loan Terms and Conditions whereby the consumer's interest rate inherits the consumer's interest rate of the prior month adjusted by changes in the relevant Interest Rate Index subject to limitations specified in the said contractual Terms and Conditions.
a means for analyzing the financial performance of any single or multi-segment loan where calculations span monthly intervals across the consumer's entire financing need duration and are calculated to reflect the consumer's expected total payment, balance and interest rate payments for each permuted loan scenario;
a means to financially model and project the performance of multiple loans, each loan consisting of one or more segments, across a consumer's financing need duration;
a means to create a specific Scenario Instance using iterative techniques that identifies an initial loan, hypothetical refinance loan, and refinance timing for a given interest rate scenario;
a means to calculate for each said Scenario Instance the Net Present Value (NPV) of the full debt life cycle costs including all principal repayment, interest charges, fees and penalties utilizing said Discount Rate;
a means to derive an Evaluation Metric that represents the degree to which a Scenario Instance meets the consumer's requirements and preferences responded to in the Consumer Questionnaire;
a means to calculate a single Hybrid Metric that factors said Scenario Instance's Evaluation Metric and Net Present Value;
a means for storing said Hybrid Metric into a 3-dimensional array designed for post process optimization, whereby said 3-dimensional array aggregates across all said Scenarios Instances, and where array entries are indexed by the permuted cases of the Initial Loan, a hypothetical refinance loan, and refinance timing.

6. A method providing the consumer client with results of the home mortgage loan analysis in a coherent format containing:
a means to evaluate, compare and therefore select the results of the determination of the most effective home mortgage loan strategy as the optimum said Hybrid Metric stored in said 3-dimensional array;
a means to evaluate, compare and therefore select a Best Single Loan Scenario constrained by a no refinance alternative;
a means to evaluate, compare and therefore select a Best Multiple Loan Scenario consisting of a best Initial Loan and an optimally timed, future hypothetical Refinance Loan;
a means to clearly present and so interpret said results of both the Best Single loan Scenario and Best Multiple Loan Scenario to the consumer client;
A means to clearly present and so interpret a comprehensive projection of the consumer client's stated financing need, presenting said projection on a monthly basis over the entire duration of the financing need of the mortgaged asset, and including statistics such as: total balance remaining; total monthly payment; interest portion of payment; principal portion of payment; additional fees; loan payment success probability; assessed Net Present Value.

7. The method recited in claim 1 wherein said consumer's financial and credit status include but are not limited to: maximum monthly payment client may sustain; expected duration of the loan; probability of sustained income; expected income increase/decrease; monthly payment variance limits; client's risk tolerance for possible lower payments versus stable payments.

8. The method recited in claim 1 wherein said loan interest rate futures are projected using historical loan indices data charting market performance over recent decades and Monte Carlo simulation techniques.

9. The method recited in claim 1 wherein said output results should contain at least this information for loans that should not be refinanced: (a) success probability of an initial loan; (b) projected net present value (NPV) of the loan; (c) the expected financial behavior of the loan.

10. The method recited in claim 1 wherein said output results should contain at least this information for loans that should be refinanced: (a) the average success probability of the initial and refinance loan combination; (b) the average projected net present value (NPV) of the initial and refinance loan combination; (c) the expected financial behavior of the initial loan and each subsequent refinance segment of the loan.

11. A system for providing a plurality of clients with the ability to quickly, automatically, quantitatively and comprehensively determine an optimal home mortgage loan solution from an otherwise incomprehensible array of choices in the common market comprising:
a means which collects a given client's data specific to said client's financial and credit status, loan profile preferences and client's preference for risk tolerance;
a means to support a plurality of input sources for said client's data;
a means to generate loan interest rate futures and volatility, based on the observed statistical properties of standard interest rate indices commonly found in the lending marketplace;
a means to canonically represent said user data and loan interest data;
a means to project the financial behavior of loans as distinct scenarios, given their properties and interest rate scenarios;
a means for determining the lowest net present value (NPV) of the total cost of said mortgage loan over a specific time period, from a plurality of home mortgage and home refinancing options available based on a plurality of possible scenarios derived from interest rate projections and stated client criteria;
a means for delivering the results of said optimal loan to the client in a suitable output media and format based on said client's disposition.

12. The system recited in claim 11 wherein said system is a computer program.

13. A system recited in claim 11 wherein said system manages and controls the interoperability of various input and output devices wherein said input devices include but are not limited to computer programs hosted on private or public (Internet) computer servers or computer workstations, computer databases or data files, computerized financial planning systems, computerized personal money manager programs and said output devices include but are not limited to printer devices, computer document or data files, computer databases, e-mail messages, faxes, or output is returned to said computer programs also serving as input devices.
